(19) United States
(12) Patent Application Publication
(10) Pub. No.: US 2002/0054781 A1
(43) Pub. Date: May 9, 2002

(54) Method for environmentally-friendly textile transportation in printing systems and a system thereof cross-reference to related applications

(76) Inventor: Aharon Korem, Herzliya (IL)

Correspondence Address: Eitan, Pearl, Latzer & Cohen-Zedek, Suite 210, One Crystal Park, 2011 Crystal Drive, Arlington, VA, 22202-3709, US

(21) Appl. No.: 09/986,180

(22) Filed: Nov. 7, 2001

Related U.S. Application Data
(60) Provisional application No. 60/246,071, filed on Nov. 7, 2000.

(51) Int. Cl. B41J 11/70

(52) U.S. Cl. 400/621; 400/617; 400/613; 400/614

(57) ABSTRACT

A method and system for printing on a dimensionally-unstable substrate, such as textile is provided. According to some embodiments of the present invention, the method comprising pressing the substrate onto an adhesive surface of a dimensionally-stable film, thus forming a unified dimensionally-stable substrate and substantially immediately thereafter advancing the unified dimensionally-stable substrate in a predetermined direction while printing.

### CROSS-REFERENCE TO RELATED APPLICATIONS

The present application claims priority from U.S. provisional application serial No. 60/ 246,071, filed Nov. 7, 2000.

### BACKGROUND OF THE INVENTION

At present, textile printing is dominated by flat-bed screen-printing and rotary screen-printing. Both methods requite making a plate and are hence unfit for small-quantity production. In contrast to conventional screen textile printing, in digital textile printing, such as, for example inkjet printing an original plate is not required, thus enabling small-quantity production at lower costs and on-demand.

Fabric is usually a flexible, dimensionally unstable material, namely, it tends to stretch and/or to move in an uncontrollable manner during its transportation. Consequently, misregistration, incomplete overlap between color separations, and distortion of the image may occur.

In existing textile-printing systems, a conveyor such as a porting belt is coated with an adhesive during the printing process. The printing material is temporarily adhered to the coated conveyor to maintain flatness and stability, and is transported, beneath the printing cylinders, in a predefined direction either continuously or intermittently. At the end of the printing process, the printed material is pulled off the sticky conveyor and rolled onto a take-up roller.

During printing, however, the adhesive may absorb some ink and its adhesive power may weaken. Therefore, the adhesive is removed after some printing cycles, and a new layer of adhesive is coated onto the conveyor surface.

These processes, which take place during printing, use dangerous chemicals, such as adhesives and solvents and toxic gas may be present in the work environment.

They also require the printing system to comprise additional subsystems, which require high-electricity power, external water supply and connection to the sewage system.

Another method of digital printing on textile uses a roll of fabric previously wound together with a paperback for achieving the stability required for the printing process. This method is, however, most expensive and limited in use

It would be advantageous to have a stand-alone environmentally-friendly textile printing system able to operate at a non-industrial facility,

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic sectional view of a printing system having a transportation unit according to some embodiments of the present invention;

FIG. 2 is a schematic sectional view of a printing system according to some embodiments of the present invention; and

FIG. 3 is a schematic sectional view of a printing system having a cutting unit according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some embodiments of the present invention are directed to an environmentally-friendly textile printing system capable of operating in an office-like facility and having a transporting mechanism that enables dimension stability of the fabric being transported and high accuracy. Fabric is usually a flexible, dimensionally unstable material, namely, it tends to stretch and/or to move in uncontrollable manner during its transportation.

In order to control the movement of the fabric so as to avoid misregistration and distortion of the printed image, it may be temporarily attached to a dimensionally stable sticky film. During printing, a transporting mechanism may convey the film together with the fabric in a controllable and accurate manner.

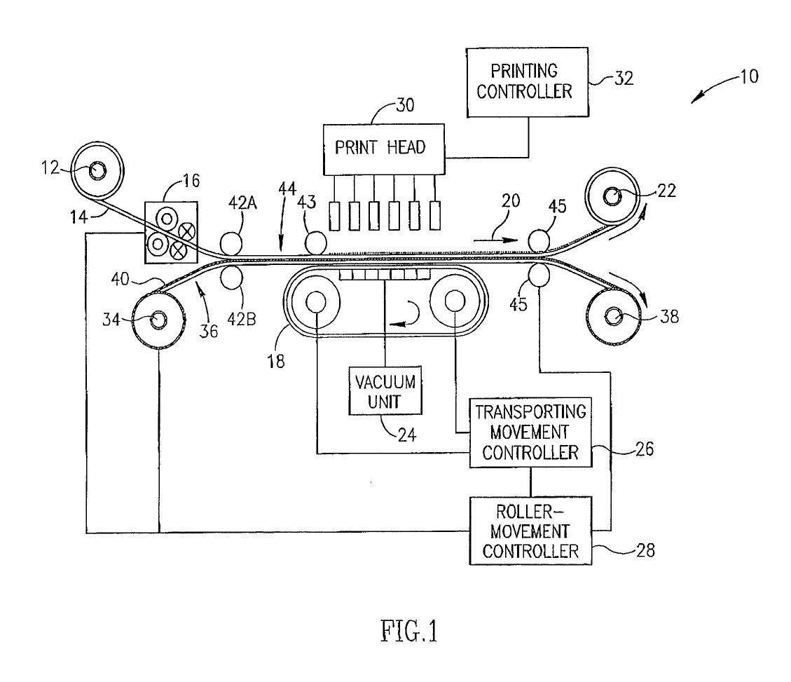

In some embodiments, which will be described hereinbelow with respect to FIG. 1, the transporting mechanism may be a vacuum-loaded conveyer, such as, for example, a rotating transporting belt and a rotating drum. Alternatively, the transporting mechanism may be a vacuum-loaded table described in PCT Patent Application PCT/IL01/00089, filed Jan. 30, 2001, which is incorporated inhere by reference.

For these embodiments, only the top surface of the stable film may be adhesive, while the bottom surface is attachable to the surface of the transporting mechanism by vacuum. In the embodiments described with respect to FIG. 1, a vacuum system is used to attach the print material to the transporting mechanism. However, it should be understood to a person skilled in the art that other attachment systems might be used, including but not limited to electrostatic and magnetic systems.

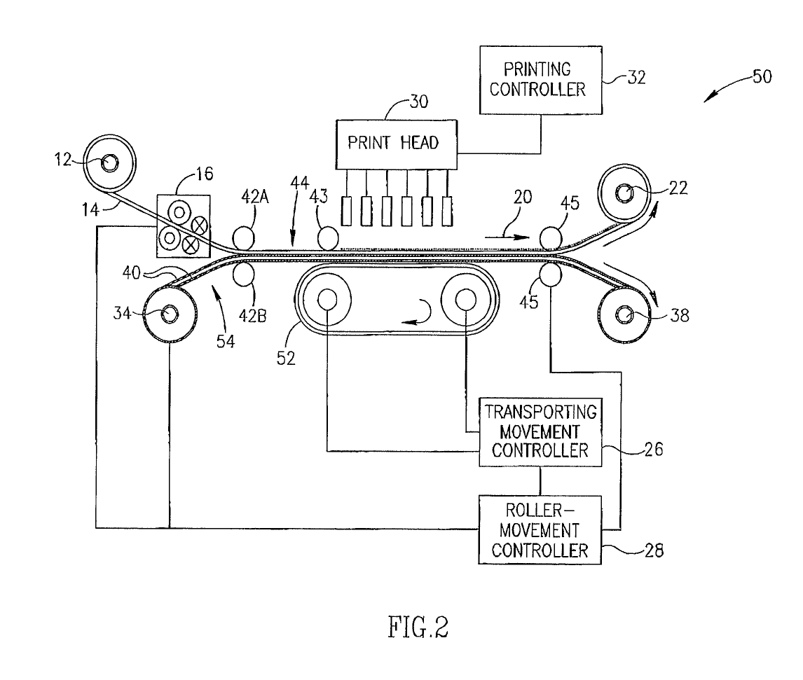

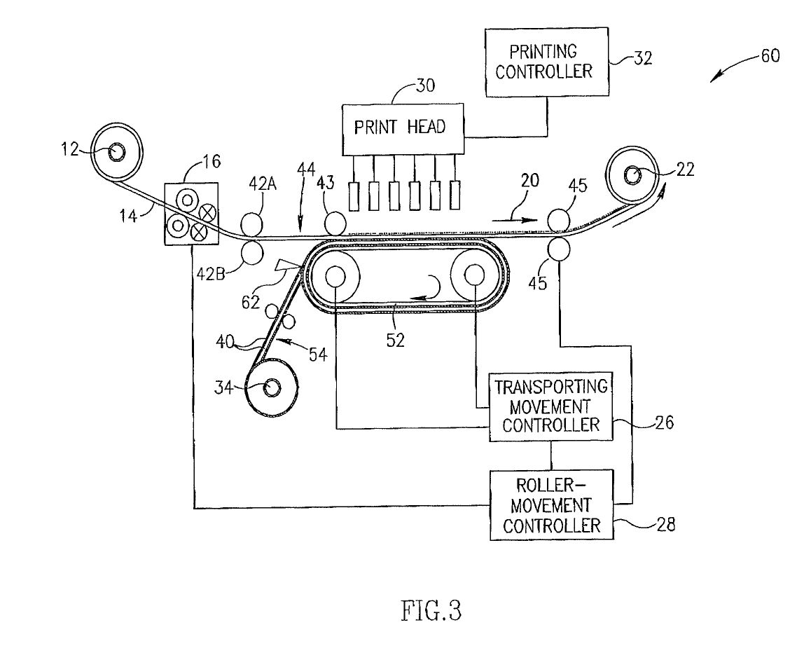

In other embodiments, which will be described hereinbelow with respect to FIG. 2, the film has two adhesive surfaces. An adhesive bottom surface may adhere to the surface of the transporting mechanism, Bus eliminating the need for a vacuum unit or any other attachment mechanism. FIG. 3 describes other embodiments in which, before printing, the film is cut at a length corresponding to the perimeter of the outer surface of the conveyor and is attached thereon.

These embodiments represent an environmentally-friendly printing system capable in operating in an office-like facility. According to embodiments of the present invention, no adhesive is applied at the work environment and no chemicals are needed to remove the used adhesive film. Consequently, no toxic gas is inhaled and there are no chemicals flushed to the sewage system. Additionally, used film may be pulled off the conveyor and safely disposed in a special facility or recycled.

Reference is now made to FIG. 1, which is a cross sectional schematic view of a printing system having an accurate transportation unit according to some embodiments of the present invention A printing system 10 may comprise a substrate-feed roller 12 able to carry a printing substrate 14 continuously wound in a from of a roll, and a feed and alignment unit 16 able to align printing substrate 14. Alignment unit 16 may be any unit known in the art capable of aligning dimensionally unstable materials, such as textile.

System 10 may further comprise a transporting mechanism 18, illustrated as a transporting belt, able to advance unwound substrate 14 in a predetermined direction, shown by arrow 20 and a substrate take-up roller 22 able to rewind substrate 14 after printing and drying.

Transporting mechanism 18 may operate in a continuous mode or in a step mode as known in the art.

For clarity, transporting mechanism 18 is illustrated in FIG. 1 as a closed-loop vacuum-loaded conveyer belt. However, it should be noted to a person skilled in he art that other transporting mechanisms, such as, for example, a vacuum rotating drum and a vacuum table, are equally applicable.

Conveyor belt 18 may be coupled to a vacuum unit 24. During printing, vacuum unit 24 may continuously apply a vacuum to conveyor belt 18, which may enable attaching a substrate to the top surface of belt 18 and controllably transporting it in a predefined direction.

System 10 may further comprise a transporting-movement controller 26 coupled to conveyor belt 12 and a Toller-movement controller 28 coupled to transporting-movement controller, to rollers 12, 22 and to rollers 34, 38, which will be described hereinbelow. Both movement controllers 26 and 28 may be servo control units well known in the art Movement controllers 26 and 28 may enable the synchronization between the movement of the rollers and the transporting mechanism so as to enable controllable and accurate transporting of the substrate during printing.

Printing system 10 may further comprise one or more print heads 30 movable above substrate 14 across transporting mechanism 18 for printing, and a printing controller 32 coupled to print heads 30.

For clarity, the following description uses the example of an inkjet printing system. However, it will be appreciated by persons skilled in the art that embodiments of the invention are equally applicable to other printing systems, such as for example, rotary screen printing systems and flat-bed screen printing.

Printing system 10 may further comprise a film feed roller 34 able to carry a sticky film 36 continuously wound in a form of a roll, and a film take-up roller 38 able to rewind film 36. Sticky film 36 may be a dimensionally stable sheet-like material having at least one adhesive surface comprising an adhesive 40. Non-limiting examples of such a film include plastic, vinyl, paper, or any material capable of carrying adhesive and transportable in a dimensionally stable manner. Adhesive 40 may be any adhesive having suitable adhesion and release properties.

Printing system 10 may Her comprise one or more pairs of pressure rollers 42, a roller 43 and a pair of rollers 45. Pressure roller 42A may be positioned above substrate 14 and pressure roller 42B may be positioned below sticky film 36, so as to press the substrate onto an adhesive top surface of film 36.

The transporting path of the print material may be as follows: Substrate 14 may be unwound as feed roller 12 is rotated and may be aligned using alignment unit 16. Substantially concurrently, film 36, which has an adhesive top surface, may be unwound as feed roller 34 is rotated. Both substrate 14 and film 36 may be fed between one or more pressure rollers 42 onto transporting mechanism 18. Rollers 42 may adhesively press substrate 14 onto film 36 to form a united dimensionally stable layered material 44. Roller 43 may press united material 44 onto transporting mechanism 18

Transporting belt 18 may be operated while the united material 44 is attached to the top surface of transporting belt 18 with vacuum so that material 44 is advanced in a direction shown by arrow 20 during printing. After printing on a portion of substrate 14, united material 44 may be peeled off from transporting belt 18 and united material 44 may be disunited using rollers 45. Printed substrate 14 may then be wound by take-up roller 22 and used film 36 may be wound by take-up roller 38.

Reference is now made to FIG. 2, which is a cross sectional schematic view of a painting system having a substrate transportation unit according to some embodiments of the present invention. A printing system 50 is similar to printing system 10 and elements in common have the same reference numbers.

Printing system 50 may comprise a vacuum-less transporting mechanism 52. Non-limiting examples of such a mechanism may include a conveying belt, as shown in FIG. 2, and a rotating drum. In these embodiments, a dimensionally stable sheet-like film 54 laving two adhesive surfaces is used. During printing, the top surface of film 54 may be adhesively attached to a bottom surface of substrate 14, as described with respect to FIG. 1, while the bottom surface of film 54 may be adhesively attached to the top surface of transporting belt 52.

Reference is now made to FIG. 3, which is a cross sectional schematic view of a printing system having a cutting unit according to some embodiments of the present invention. Printing system 60 may comprise a cutting unit 62 able to cut film 54. Before printing, the film is cut at a length corresponding to the perimeter of the outer surface of the conveyor and is attached thereon so as to adhesively cover its outer surface. In these embodiments, after a predetermined number of printing cycles, the used portion of film 54 may be removed, either manually or automatically, and may be replaced with a new portion of film 54.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A printing system for printing on a dimensionally-unstable substrate, the printing system comprising:
a dimensionally-stable film having an adhesive top surface;
one or more pairs of pressure rollers, each pair comprising a pressure roller positioned above said dimensionally-unstable substrate and a pressure roller positioned below said film, so as to press said substrate onto said adhesive top surface, thus forming a unified dimensionally-stable substrate; and
a conveyor able to advance said unified dimensionally-stable substrate in a predetermined direction during printing on said dimensionally-unstable substrate.

2. The prizing system of claim 1, wherein said dimensionally-unstable substrate is fabric,

3. The printing system of claim 1, further comprising:
a vacuum system coupled to said conveyor, said conveyor having openings therein that enable a vacuum produced by said vacuum system to hold a non-adhesive bottom surface of said film in contact with said conveyor.

4. The printing system of claim 3, wherein said conveyor is a belt.

5. The printing system of claim 3, wherein said conveyor is a drum.

6. The printing system of claim 3, wherein said conveyor is a conveyance table having two or more movable elements and two or more fixed elements, wherein said vacuum system is able to produce said vacuum so that said film is alternately attached to said movable elements and to said fixed elements.

7. A printing system for printing on a dimensionally-unstable substrate, the printing system comprising:
a dimensionally-stable film having an adhesive top surface and an adhesive bottom surface;
one or more pairs of pressure rollers, each pair comprising a pressure roller positioned above said dimensionally-unstable substrate and a pressure roller positioned below said film, so as to press said substrate onto said adhesive top surface, thus forming a unified dimensionally-stable substrate; and
a conveyor able to advance said unified dimensionally-stable substrate in a predetermined direction during printing on said dimensionally-unstable substrate.

8. The printing system of claim 7, said adhesive bottom surface of said dimensionally-stable film is attachable to said conveyor when said conveyor advances said unified substrate.

9. The printing system of claim 7, wherein said conveyor is a belt.

10. The printing system of claim 7, wherein said conveyor is a drum.

11. The printing system of claim 7, wherein said dimensionally-unstable substrate is fabric.

12. A printing system for printing on a dimensionally-unstable substrate the printing system comprising:
a dimensionally-stable double-sided adhesive film; and
a conveyor wrapped with said film, said film adhering to said dimensionally-unstable substrate while said conveyor advances said dimensionally-unstable substrate in a predetermined direction during printing thereon.

13. The printing system of claim 12, further comprising:
a cutting unit able to cut said film to a predetermined length.

14. The priming system of claim 12, wherein said conveyor is a belt.

15. The printing system of claim 12, wherein said conveyor is a drum.

16. The printing system of claim 12, wherein said dimensionally-unstable substrate is fabric.

17. A method comprising:
pressing a dimensionally-unstable substrate onto an adhesive surface of a dimensionally-stable film, thus forming a unified dimensionally-stable substrate; and
substantially immediately thereafter, advancing said unified dimensionally-stable substrate in a predetermined direction while printing on said dimensionally-unstable substrate.

18. The method of claim 16, wherein advancing said unified substrate comprises continuously advancing said unified substrate.

19. The method of claim 17, wherein advancing sad unified substrate comprises intermittently advancing said unified substrate.

20. The method of claim 17 further comprising;
separating said dimensionally-unstable substrate and said dimensionally-stable film.

21. A method for printing on a dimensionally-unstable substrate, the method comprising:
wrapping a conveyor with a dimensionally-stable double-sided adhesive film;
attaching said dimensionally-unstable substrate to a top adhesive surface of said film; and
advancing said dimensionally-unstable substrate adhering to said film in a predetermined direction during printing thereon.
